(19) United States
(12) Patent Application Publication
(10) Pub. No.: US 2021/0015332 A1
(43) Pub. Date: Jan. 21, 2021

(54) JOIST AND BASEBOARD APPARATUS

(71) Applicant: Lynda Lee Whittington, Plano, TX (US)

(72) Inventor: Lynda Lee Whittington, Plano, TX (US)

(21) Appl. No.: 16/511,259

(22) Filed: Jul. 15, 2019

(51) Int. Cl. A47L 13/16; B05C 17/00

(52) U.S. Cl. CPC A47L 13/16; B05C 17/00

(57) ABSTRACT

A ceiling joist and panel grove cleaner apparatus, which provides a means for applying constant cleaning positioning pressure upon both ceiling joists edges and panel groves. The cleaner apparatus comprises a mop flat head applicator with a pivotable hinged application guide, a swivel mount, a handle, an interchangeable joist-cleaning pad, and, an interchangeable panel-grove cleaning pad.

### FIELD OF THE INVENTION

The invention relates generally to apparatus for dusting, cleaning and coatings application.

### BACKGROUND OF THE INVENTION

Various dusting tools for removing dust from ceiling joists are known in the art and typically include a feathered duster or the like mounted to a pole handle. A common problem encountered with the foregoing apparatus is the inability to apply even pressure to the surfaces to be cleaned, and the inadequate cleaning of corners.

It would be desirable to provide an apparatus adapted to clean ceiling joists that enables a user to apply even pressure along the length of the joist to ensure simultaneous thorough cleaning of both the joist leading edge and the joist side surfaces, including the corners where the joists and ceiling meet. After cleaning or painting both the joist leading edge and the joist side, the joist leading edge can be rotated and snapped out of the way so now just the opposite joist side can be cleaned or painted without having to paint or clean the joist leading edge again. An advantage here is that you do not have to take down the cleaning apparatus from the ceiling to the floor to take off the leading edge guide (pivotable hinged leading edge joist guide plate). To explain again, the apparatus can stay up in the air on the pole to clean both the leading edge and one joist side, then gently knocking (pivoting and snapping into place) the leading edge guide somewhere on the ceiling out of the way to clean the other joist side without re clearing the joist edge. This is a huge time saving advantage.

It is desirable if the foregoing apparatus were convertible to a baseboard cleaner capable of cleaning surfaces, including the corners where the baseboards and floor meet. It would be even more desirable if the foregoing apparatus can clean the surface area of the leading edge of the joist simultaneously with cleaning either side surface areas of the joist as well.

### SUMMARY OF THE INVENTION

One general example implementation of a ceiling joist and baseboard cleaner includes an extendable handle mounted to a application face pivotable hinged application guide plate. The application face pivotable hinged application guide plate and handle are connected by a swivel-type joint that may include a universal joint, a ball joint or any suitable coupling to permit swivel motion of the application face pivotable hinged application guide plate relative to the handle. The application face pivotable hinged application guide plate is hingeably connected to a pivotable hinged leading edge joist guide plate. Both the first and pivotable hinged leading edge joist guide plates include a pad mounting surface.

The apparatus includes one or more interchangeable pads that may include fine and course texture, fabric loops, etc., adapted for dust removal and the application of coatings such as polish, cleaners, stains and paint.

In a first aspect combinable with the general implementation, apparatus includes a hinge member, permitting the repositioning of the pivotable hinged leading edge joist guide plate in relation to the application face pivotable hinged application guide plate.

In a second aspect combinable with any of the previous aspects, the apparatus has at least a first position wherein the pad mounting surfaces of the first and pivotable hinged leading edge joist guide plates are 90 degrees relative to one another.

In a third aspect combinable with any of the previous aspects, the apparatus has at least a second position wherein the pad mounting surfaces of the first and pivotable hinged leading edge joist guide plates are

180 degrees from one another.

In a fourth aspect combinable with any of the previous aspects, the apparatus has at least a second position wherein the pad mounting surfaces of the first and pivotable hinged leading edge joist guide plates are

270 degrees from one another.

In a fifth aspect combinable with any of the previous aspects, pads may be secured to the pad mounting surfaces by hook and loop fasteners, clamp fasteners, light tack adhesives or any other suitable attachment means that would suggest itself to those having skill in the art.

In a sixth aspect combinable with any of the previous aspects, the swivel-type joint may be a ball and socket joint that permits the application face pivotable hinged application guide plate to swivel in multiple directions.

In a seventh aspect combinable with any of the previous aspects, the swivel-type joint may be a universal yoke coupling that permits the application face pivotable hinged application guide plate to swivel in multiple directions.

In an eighth aspect combinable with any of the previous aspects, at least two sides of the application face pivotable hinged application guide plate are substantially parallel to at least two sides of the pivotable hinged leading edge joist guide plate.

In a ninth aspect combinable with any of the previous aspects, the first and pivotable hinged leading edge joist guide plates are joined by a hinge member along adjacent sides.

In a tenth aspect combinable with any of the previous aspects, a hinge member joining the first and pivotable hinged leading edge joist guide plates may be tensionable such that the plates may be maintained in a desired position in relation to one another.

In an eleventh aspect combinable with any of the previous aspects, the hinge member may include a ratcheting type hinge that may be set at at least two positions.

In a twelfth aspect combinable with any of the previous aspects, the hinge member and the swivel joint include a tensioning element for increasing or decreasing the hinge/joint resistance to movement.

In a thirteenth aspect combinable with any of the previous aspects, the extendable handle may be a telescoping pole construction.

In a fourteenth aspect combinable with any of the previous aspects, an interchangeable pad may be a single pad adapted to fold lengthwise when the first and pivotable hinged leading edge joist guide plates are repositioned, or two separate pads, each pad mounted to a separate plate.

These general and specific aspects may be implemented using a device, system or method, or any combinations of devices, systems, or methods. The details of one or more implementations are set forth in the accompanying drawings and the description. Other features, objects, and advantages will be apparent from the description and drawings, and from the claims.

### BRIEF DESCRIPTION OF THE DRAWING FIGURES

FIG. 1 is a perspective view of an example embodiment according to the present invention;

FIG. 2 is a perspective view of one end of the example embodiment in (FIG. 1);

FIG. 3 is a side elevation thereof;

FIG. 4 is a side elevation thereof showing translation of a pivoting plate of (FIG. 3);

FIG. 5 is another side elevation thereof;

FIG. 6 is a perspective view thereof showing a joist cleaning configuration;

FIG. 7 is a perspective view thereof showing a baseboard cleaning configuration;

FIG. 8 shows the apparatus configured for a flat surface.

### REFERENCE LISTING OF THE NUMBERED ELEMENTS

100 joist and baseboard apparatus
103 telescoping handle
104 inner pole member
106 outer pole member
108 pole lock
110 grip
112 application face pivotable hinged application guide plate
113 application face pivotable hinged application guide plate pad mounting surface
114 swivel joint
116 swivel joint mount
117 swivel tensioner
118 hinge member
119 hinge tensioner
120 pivotable hinged leading edge joist guide plate
121 pivotable hinged leading edge joist guide plate pad mounting surface
122 flexible pad
124 pad attachment member
128 swivel joint stiffener
200 joist/beam
202 baseboard

### Definitions

The term “comprises” means “includes.” The term “pad” means any soft applicator, whether of natural material or synthetic that is capable of attracting and retaining dust, or, applying a coating to a surface. The term “coating” or “coatings” means any fluid material that may be a cleaning compound, a polish, a sealer, a stain or paint. The term “swivel” means pivoting and multi-axis movement. The term “joist” means a beam that may be abutting a surface or a stand alone beam in either a decorative or actual supportive capacity. The term “pad mounting surface” refers to the side of the plates configured to receive and retain a pad. The term “hinge member” means a hinge that permits pivotable movement within limits and may include a ratcheting type hinge similar to Model HG-RCT12-C available from Sugatsune America, Inc 18101 Savarona Way, Carson, Calif. 90746, that requires sufficient force to be applied in order to transition the hinge member from one discrete angular position to another, or Constant Torque Position Control Hinge similar to class E6/ST available from Southco® Inc., 210 North Brinton Lake Road, Concordville, Pa. 19331-0116, or tensionable piano type hinges that may have a adjustable end cap for increasing or decreasing the resistance to movement. Although methods and materials similar or equivalent to those described herein can be used in the practice or testing of this disclosure, suitable methods and materials are described below. It should be understood that the objects, features and aspects of any implementation or embodiment disclosed herein may be combined with any object, feature or aspect of any other implementation/embodiment without departing from the scope of the invention.

### DETAILED DESCRIPTION OF THE EMBODIMENTS

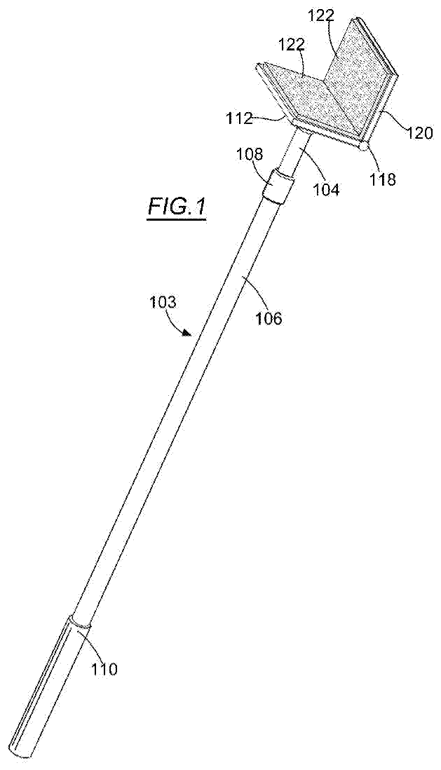

Referring generally to FIGS. 1-9, an apparatus (100) configured for the cleaning of joists (200) and baseboards (202) includes an extendable handle (103) joined to a application face pivotable hinged application guide plate (112) by a swivel-type coupling (114), and, a pivotable hinged leading edge joist guide plate (120) joined to the application face pivotable hinged application guide plate (112) such that the first and pivotable hinged leading edge joist guide plates are moveable in relation to one another. A hinge member (118) joining the plates (112, 120) and the swivel-type coupling (114) are tensionable, typically by a adjusting a screw or knob (117, 119) that causes an internal element to bear against the internal surfaces of the respective components. Each plate includes a pad mounting surface (113, 121) configured to accept and retain a flexible pad (122) that may be specialized for dusting, or coatings application.

FIG. 1 shows the entire apparatus with telescoping handle that includes inner (104) and outer (106) pole members and their relationship to the first (112) and second (120) plates.

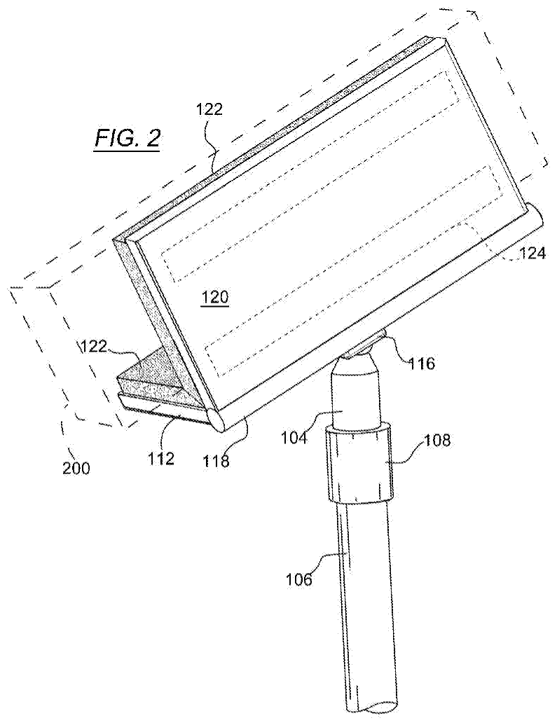

FIG. 2 is a partial perspective view showing a handle portion with pole lock (108) that may be twisted to maintain the poles in a desired telescoped position, and the first and pivotable hinged leading edge joist guide plates in a position suitable for cleaning a joist (200) wherein the pad mounting surfaces (113, 121) of the plates are generally 90 degrees apart. Dashed line (124) represents an example hook and loop fastener adapted to attach to a corresponding fastener on a flexible pad (122). Other suitable securing methods for attaching the pads will be appreciated by those having skill in the art. Pads (124) may be interchanged and may include a number of textures, materials and other features for specialized cleaning or coating applications.

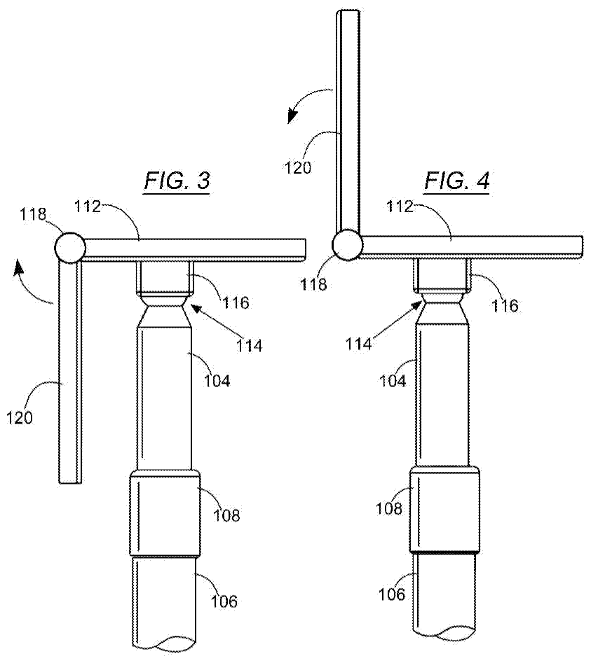

FIGS. 3 and 4 are partial side elevations showing two possible positions of the first (112) and second (120) plates.

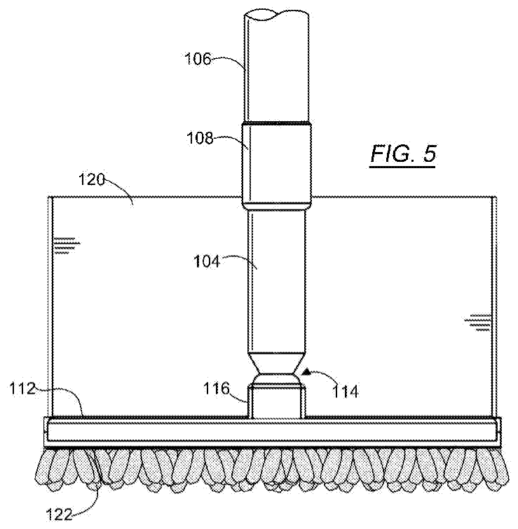

FIG. 5 is a partial side elevation showing the swivel-type joint (114) that joins the handle (103) to the application face pivotable hinged application guide plate (112). In the illustration, the mounting surfaces of the first and pivotable hinged leading edge joist guide plates are 270 degrees apart. Flexible pad (122) includes a looped construction.

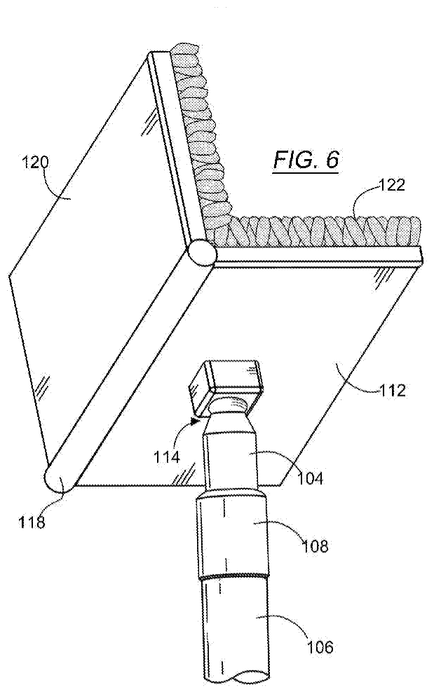

FIG. 6 is a partial perspective view showing apparatus (100) in a joist-cleaning configuration where the mounting surfaces of the first and pivotable hinged leading edge joist guide plates are 90 degrees apart, and further depicts the swivel-type joint (114) connecting inner pole (104) to the application face pivotable hinged application guide plate (112).

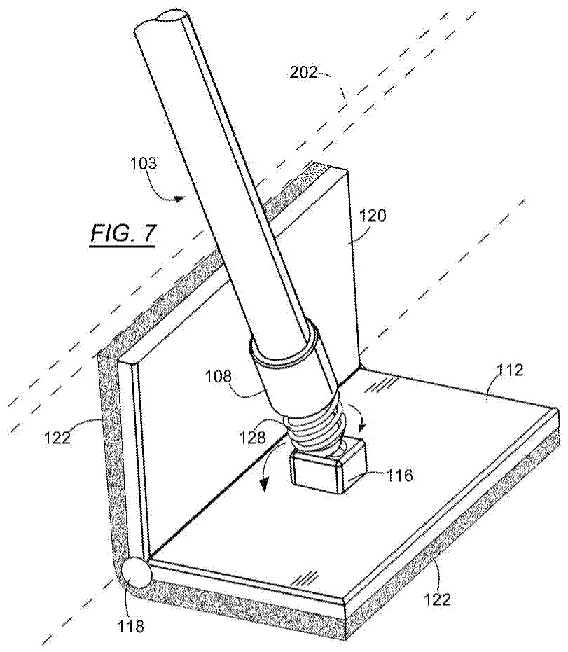

FIG. 7 is a partial perspective view showing apparatus (100) in a baseboard cleaning configuration, and further depicts swivel joint stiffener (128) that may take the form of a coil spring circumjacent the swivel-type joint (114).

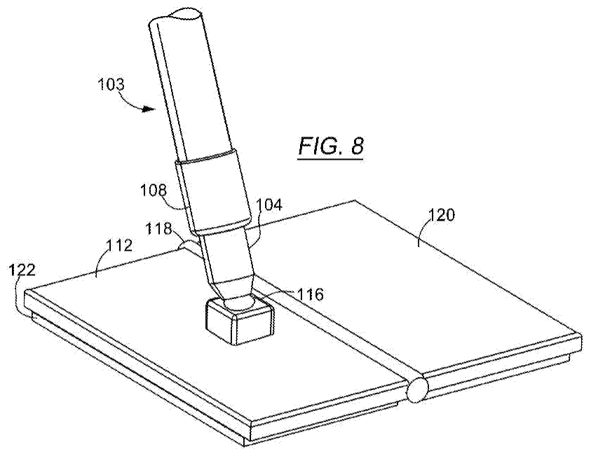

FIG. 8 is a partial perspective view showing apparatus (100) in a flat surface cleaning configuration where the pad mounting surfaces are 180 degrees apart,

What is claimed is:

1. A joist and baseboard apparatus comprising:
a handle assembly with a first end and a second end, the first end terminating with a swivelable joint;
a plate assembly including: a application face pivotable hinged application guide plate, a pivotable hinged leading edge joist guide plate and a hinging member; the application face pivotable hinged application guide plate includes a mounting side mountable to the swivelable joint, and the application face pivotable hinged application guide plate and pivotable hinged leading edge joist guide plate each include a pad mounting side adapted to receive and retain a portion of a pad member; and,
the application face pivotable hinged application guide plate and pivotable hinged leading edge joist guide plate are connected to a hinge member.

2. The joist and baseboard apparatus according to claim 1 wherein the application face pivotable hinged application guide plate is configured to be rotatable about the swivelable joint.

3. The joist and baseboard apparatus according to claim 1 wherein the application face pivotable hinged application guide plate is configured to be pivotable about the swivelable joint.

4. The joist and baseboard apparatus according to claim 1 further comprising a first position configured to translate to a second position; the pad mounting sides are directly adjacent one another in the first position, and in the second position the pivotable hinged leading edge joist guide plate is 180 degrees relative to the first position.

5. The joist and baseboard apparatus according to claim 1 further comprising a pad member configured to remove dust.

6. The joist and baseboard apparatus according to claim 1 further comprising a pad member configured to apply a coating.

7. The joist and baseboard apparatus according to claim 1 including a tension member configured to tension the swivelable joint.

8. The joist and baseboard apparatus according to claim 1 wherein the handle assembly is configured to telescope.
